(19) United States
(12) Patent Application Publication
(10) Pub. No.: US 2002/0014013 A1
(43) Pub. Date: Feb. 7, 2002

(54) Knife

(75) Inventors: Dag Graupner, Eppelheim (DE); Christof Rauber, Hockenheim (DE)

Correspondence Address: SIMPSON, SIMPSON & SNYDER, PLLC, 5555 MAIN STREET, WILLIAMSVILLE, NY, 14221-5406, US

(73) Assignee: Leica Microsystems Nussloch GmbH, Nussloch (DE)

(21) Appl. No.: 09/881,163

(22) Filed: Jun. 14, 2001

(30) Foreign Application Priority Data
Jun. 15, 2000 (DE) 100 28 792.1

(51) Int. Cl. B26B 9/00

(52) U.S. Cl. 30/350; 30/346

(57) ABSTRACT

A knife for producing sections of a wide variety of specimens and/or for creating extremely high-quality surfaces, in particular for producing thin sections and semi-thin sections by means of microtomes or ultramicrotomes, preferably for examinations with an electron microscope, having a blade and a holder for the blade, is characterized in that the blade is fabricated from an artificial diamond.

### CROSS REFERENCE TO RELATED APPLICATIONS

This application claims priority of German patent application DE 100 28 792.1 filed Jun. 15, 2000 which is incorporated by reference herein.

### FIELD OF THE INVENTION

The invention concerns a knife for producing sections of a wide variety of specimens and/or for creating extremely high-quality surfaces, in particular for producing thin sections and semi-thin sections by means of microtomes or ultramicrotomes, preferably for examinations with an electron microscope, having a blade and a holder for the blade.

### BACKGROUND OF THE INVENTION

Knives of the generic type have been known from practical use for years, and are used to cut a wide variety of materials. The generic knives are used very predominantly for cutting biological specimens and industrial specimens, in particular for producing thin sections and semi-thin sections by means of microtomes, the latter referring to a wide variety of devices, for example ultramicrotomes, cryoultramicrotomes, histomicrotomes, histocryomicrotomes, or the like.

The known generic knives comprise a very particular blade, namely one made of natural diamond. To obtain the highest precision, selected single-crystal diamonds of the greatest possible purity are used. Particular attention must be paid, in this context, to optimum orientation of the cutting edge with respect to the crystal lattice, and to extremely precise prior grinding. Natural diamonds are usually ground in the direction of their principal axes (preferred direction), since this is the direction of their greatest hardness; the result is to create an extremely sharp, nick-free, and durable knife edge.

The knives known from practical use having blades made of natural diamond are, however, problematic in that they require extraordinarily laborious and therefore cost-intensive processing in order to obtain the requisite precision for the knife. The price is correspondingly high.

### SUMMARY OF THE INVENTION

It is therefore the object of the present invention to configure and further develop a knife for producing sections of a wide variety of specimens and/or for creating extremely high-quality surfaces, in particular for producing thin sections and semi-thin sections by means of microtomes or ultramicrotomes, in such a way that extremely high quality requirements and strict quality standards can be met cost-effectively with simple technical means, specifically with no need for laborious post-processing of the material.

### BRIEF DESCRIPTION OF THE DRAWINGS

The invention will be explained in more detail with reference to the drawings, in which:

FIG. 1 is a perspective view of a knife formed in accordance with an embodiment of the present invention; and

FIG. 2 is an enlarged cross-sectional view of a knife blade formed in accordance with an embodiment of the present invention.

### DETAILED DESCRIPTION OF THE INVENTION

The aforesaid object is achieved by the features of claim 1. According to the latter, the blade of the knife is fabricated from an artificial diamond.

What has been recognized according to the present invention is that laborious machining of the blade of the knife from natural diamond is not necessary in order to obtain the requisite precision. Instead, it is readily possible to fabricate the blade from an artificial diamond, the blade being already shapable and definable, in terms of its shape and adherence to the requisite quality standards, as the artificial diamond is created, so that in contrast to the use of a natural diamond, post-processing of the artificial diamond is not necessary. Independence from natural diamonds is also achieved according to the present invention.

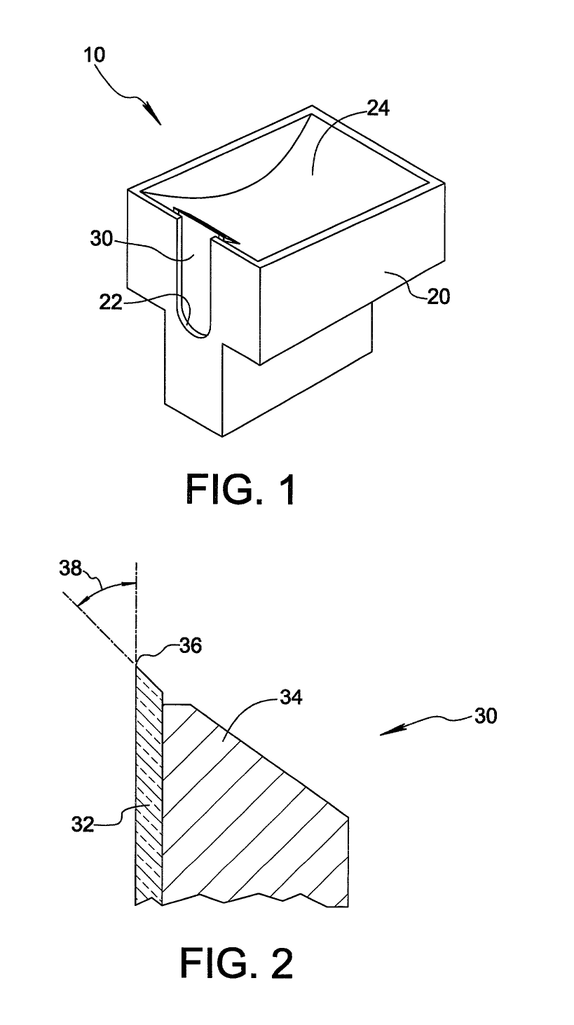

FIG. 1 shows a knife 10 comprising a blade holder 20 and a blade 30. Blade holder 20 includes an opening 22 for slidablyreceiving blade 30 and a receptacle 24 for holding water upon which a thin section of tissue (not shown) floats after being cut by blade 30.

FIG. 2 shows knife blade 30 in greater detail. In accordance with the present invention, blade 30 is formed from artificial diamond 32 and preferably includes a substrate 34 serving as a foundation of the blade, although substrate 34 can be omitted.

Concretely, the blade 30 can be directly produced or shaped by the deposition of atoms from the gas phase of carbon, the plasma CVD method being particularly suitable for the purpose. This method is assumed in this context to be known, so that further discussion thereof is superfluous. It is possible in principle to deposit atoms or ions from the gas phase of carbon, from the gas phase of carbon-containing gas mixtures, or from the gas phase of carbon-containing compounds such as, for example hydrocarbons (C2H4), directly onto a substrate 34, or to allow the artificial diamond 32 to grow on the substrate 34, the substrate serving as the foundation of the blade. The substrate could, in this context, play a stabilizing or stiffening role. The substrate 34 could be made of silicon, which is very particularly suitable for the construction of an artificial diamond.

It is also conceivable to produce the blade 30 without a foundation, namely by synthetic growth of the artificial diamond without using a substrate.

The use of an artificial diamond as the blade of the knife claimed here makes it possible to define the surfaces of the blade by controlled deposition of the atoms. This applies in particular to the cutting edge 36 and to the edge angle 38, so that the blade as a whole can be defined as the artificial diamond is produced. For example, an edge angle in the range from 35 degrees to 55 degrees can readily be established with no need for post-processing of the blade.

It is also possible to define the properties of the surfaces; specifically, the surfaces of the blade can be made hydrophilic or hydrophobic by controlled deposition of the carbon atoms.

In additionally advantageous fashion, the blade constructed from artificial diamond can be inserted into the holder 20 and clamped, screwed, glued or otherwise retained in the holder. It is also conceivable to arrange the blade pivotably or tiltably in the holder, depending on the requirement of the particular cutting apparatus.

Lastly, the blade 30 or the holder 20 can be coolable or heatable, the desired operating temperature of the blade 30 preferably being imparted to it via the holder 20.

In conclusion, be it emphasized very particularly that the aforesaid embodiments serve merely for discussion of the teaching that is claimed, but do not limit it to the aforesaid embodiments.

What is claimed is:

1. In a knife used in a microtome or an ultramicrotome for cutting thin sections for examination with a microscope, said knife having a blade and a holder for said blade, the improvement comprising:
said blade being fabricated at least in part from artificial diamond.

2. The improvement according to claim 1, wherein said blade is directly produced by deposition of atoms from the gas phase of carbon.

3. The improvement according to claim 2, wherein said blade is produced using the plasma CVD method.

4. The improvement according to claim 1, wherein atoms of said artificial diamond are deposited onto a substrate, and said substrate serves as a foundation of said blade.

5. The improvement according to claim 1, wherein atoms of said artificial diamond are grown onto a substrate, and said substrate serves as a foundation of said blade.

6. The improvement according to claim 4, wherein said substrate is made of silicon.

7. The improvement according to claim 5, wherein said substrate is made of silicon.

8. The improvement according to claim 1, wherein said blade is produced without a substrate as a foundation.

9. The improvement according to claim 2, wherein surfaces of said blade are made hydrophilic or hydrophobic by controlled deposition of atoms.

10. The improvement according to claim 2, wherein said blade includes a cutting edge, and said cutting edge is defined by controlled deposition of atoms.

11. The improvement according to claim 10, wherein an edge angle of said cutting edge is defined by controlled deposition of atoms.

12. The improvement according to claim 11, wherein said edge angle is in the range from 35 degrees to 55 degrees.

13. The improvement according to claim 1, wherein said blade is inserted into and retained in said holder.

14. The improvement according to claim 13, wherein said blade is pivotably retained in said holder.

15. The improvement according to claim 1, wherein said blade is coolable and heatable through cooling and heating said holder.

16. A method for cutting thin sections for examination with a microscope, said method comprising the steps of:
providing a knife having a blade fabricated at least in part from artificial diamond; and
using said knife in a microtome or an ultramicrotome to cut said thin sections.
